(19) United States
(12) Patent Application Publication
(10) Pub. No.: US 2019/0161068 A1
(43) Pub. Date: May 30, 2019

(54) MULTIPLE DRIVE SOURCE-EQUIPPED VEHICLE

(71) Applicant: HONDA MOTOR CO., LTD., Tokyo (JP)

(72) Inventors: Yoshiyuki Takeuchi, Wako-shi (JP); Takehiro Abe, Tokyo (JP); Masahiro Fujii, Wako-shi (JP); Toshikatsu Mori, Raymond, OH (US); Kazuhisa Nakagawa, Wako-shi (JP); Yusuke Fujii, Wako-shi (JP)

(21) Appl. No.: 16/172,977

(22) Filed: Oct. 29, 2018

(30) Foreign Application Priority Data
Nov. 27, 2017 (JP) 2017-226623

(51) Int. Cl. B60W 10/26; B60W 10/08; B60W 20/13; B60H 1/00

(52) U.S. Cl. CPC B60W 10/26; B60W 10/08; B60W 20/13; B60H 1/2218; B60H 1/00028; B60H 1/00392; B60H 1/00885; B60H 1/00807

(57) ABSTRACT

A multiple drive source-equipped vehicle includes two temperature detection parts configured to detect a temperature of external air. When a heating operation is performed at a time of vehicle driving by a first drive source, the controller determines whether or not an external air temperature is lower than a predetermined value based on a detection temperature of a temperature detection part of which a detection temperature is higher among the two temperature detection parts. The controller continues a heating operation by a first heating apparatus when it is determined that the external air temperature is not lower than the predetermined value. The controller operates the second drive source and performs a heating operation by a second heating apparatus when it is determined that the external air temperature is lower than the predetermined value.

### CROSS-REFERENCE TO RELATED APPLICATION

Priority is claimed on Japanese Patent Application No. 2017-226623, filed on Nov. 27, 2017, the contents of which are incorporated herein by reference.

### BACKGROUND

### Field of the Invention

The present invention relates to a multiple drive source(energy)-equipped vehicle such as a hybrid vehicle that is equipped with an internal combustion engine and an electric motor or a plug-in hybrid vehicle that is capable of being charged by an external electric source.

### Background

Most vehicle air conditioners have a configuration in which an external air temperature is detected together with an internal air temperature, an amount of insolation, and the like, and an air conditioning function is controlled on the basis of these detection values. An external air temperature sensor that detects a temperature outside the vehicle is provided generally at a front part of a radiator, in the vicinity of a bumper, and the like (for example, refer to Japanese Patent Application, Publication No. S63-93610).

In a hybrid vehicle that is equipped with an internal combustion engine and an electric motor, when the vehicle is driven by only the electric motor, it is impossible to perform a heating operation in which the combustion heat of the internal combustion engine is used. Therefore, generally, a heating operation in which an electric heater is used is performed in a vehicle drive mode by only the electric motor, and a heating operation in which the combustion heat of the internal combustion engine is used is performed in a vehicle drive mode by the internal combustion engine.

In a hybrid vehicle, even at the time of the vehicle being driven by the electric motor, when an external air temperature is low and a quick heating cannot be performed by only the electric heater, when the residual amount of the battery is low, and the like, there may be cases in which the internal combustion engine is started and the heating operation is switched to a heating operation in which the combustion heat of the internal combustion engine is used.

Even in a case of the hybrid vehicle described above, the external air temperature sensor that is used by the air conditioner is arranged at the front part of the radiator, in the vicinity of the bumper, and the like. At the time of the heating operation, the air conditioner appropriately performs the heating operation in which the electric heater is used and the heating operation in which the combustion heat of the internal combustion engine is used on the basis of the state of the vehicle drive mode and a detection value of the external air temperature sensor.

### SUMMARY

In the hybrid vehicle described above, since the external air temperature sensor is provided outside the vehicle room, rainwater, vehicle wash water, frost, and the like may be attached to a temperature detection part of the external air temperature sensor, and in that case, the detection accuracy of the temperature detection part of the external air temperature sensor is temporarily degraded. Further, when a temperature drift and the like occur at the external air temperature sensor due to aging, the detection accuracy of the external air temperature sensor is degraded.

In the hybrid vehicle described above, when the detection accuracy of the temperature detection part of the external air temperature sensor is degraded, at the time of the heating operation being performed, at a higher external air temperature than the intended external air temperature, the heating operation in which the electric heater is used is switched to the heating operation in which the combustion heat of the internal combustion engine is used. In this case, there is a concern that the fuel is unnecessarily consumed by the internal combustion engine and the frequency of fuel resupply is increased.

An aspect of the present invention is intended to provide a multiple drive source-equipped vehicle capable of preventing an unnecessary operation of a drive source caused by the degradation of a detection accuracy of a temperature detection part of an external air temperature sensor and reducing the consumption of in-vehicle energy other than electric power of a battery.

An aspect of the present invention is a multiple drive source-equipped vehicle that includes: a battery that is capable of storing electric power; a first drive source that is capable of driving a vehicle by the electric power that is stored in the battery; a second drive source that is capable of driving the vehicle by consuming in-vehicle energy other than the electric power that is stored in the battery; a first heating apparatus that is capable of heating a vehicle room inside by using the electric power that is stored in the battery; a second heating apparatus that is capable of heating the vehicle room inside by using heat that is generated by an operation of the second drive source; and a controller that performs a drive control of the first drive source, a drive control of the second drive source, a control of a heating operation by the first heating apparatus, and a control of a heating operation by the second heating apparatus, the vehicle including two temperature detection parts configured to detect a temperature of external air, wherein, when a heating operation is performed at a time of vehicle driving by the first drive source, the controller: determines whether or not an external air temperature is lower than a predetermined value based on a detection temperature of a temperature detection part of which a detection temperature is higher among the two temperature detection parts; continues a heating operation by the first heating apparatus when it is determined that the external air temperature is not lower than the predetermined value; and operates the second drive source and performs a heating operation by the second heating apparatus when it is determined that the external air temperature is lower than the predetermined value.

In the configuration described above, when a heating operation is performed at the time of vehicle driving by the first drive source in which the electric power of the battery is used, the controller compares detection values of the two temperature detection parts and determines whether or not the external air temperature is lower than the predetermined value on the basis of the detection temperature of the temperature detection part of which the detection temperature is higher. When it is determined that the external air temperature is not lower than the predetermined value, the heating operation by the first heating apparatus in which the electric power of the battery is used is continued. On the other hand, when it is determined that the external air temperature is lower than the predetermined value, the second drive source is operated, and the heating operation by the second heating apparatus is performed.

Since the multiple drive source-equipped vehicle according to an aspect of the present invention determines the external air temperature on the basis of the detection temperature of the temperature detection part of which the detection temperature is higher among the two temperature detection parts, even when the detection accuracy of any one of the temperature detection parts is degraded, it is possible to avoid an operation start of the second drive source on the basis of a detection result of a temperature detection part of which the detection accuracy is degraded.

When a temperature difference between detection temperatures by the two temperature detection parts is larger than a predetermined temperature difference, the controller may determine that a detection accuracy of any one of the temperature detection parts is degraded and may stop performing the heating operation by the second heating apparatus.

In this case, when it is determined that the detection accuracy of any one of the temperature detection parts is degraded on the basis of the temperature difference between detection temperatures, the performing of the heating operation by the second heating apparatus is stopped. Therefore, after this, if the detection accuracy of the remaining temperature detection part is degraded, it is possible to avoid the heating operation by the second heating apparatus being performed on the basis of an erroneous detection temperature.

The multiple drive source-equipped vehicle may further include an alarm apparatus configured to set off an alarm indicating a failure of the temperature detection part, wherein when a temperature difference between detection temperatures by the two temperature detection parts is larger than a predetermined temperature difference, the controller may determine that a detection accuracy of any one of the temperature detection parts is degraded and may operate the alarm apparatus.

In this case, when the detection accuracy of any one of the temperature detection parts is degraded, it is possible to promptly notify an occupant or an operator of the degradation of the detection accuracy of any one of the temperature detection parts by the alarm apparatus. When the alarm apparatus is operated, the performing of the second heating apparatus by the controller is not performed, but by way of the operation of the alarm apparatus, it is possible for the occupant to know the stopping of the performing of the second heating apparatus by the controller. Therefore, when the vehicle room inside is not sufficiently warmed, it is also possible for the occupant, by way of a manual operation, to perform the heating by the second heating apparatus.

The first drive source may be constituted of an electric motor, and the second drive source may be constituted of an internal combustion engine.

In this case, it is possible to avoid the internal combustion engine being unnecessarily started at the time of the heating operation due to the degradation of the detection accuracy of the temperature detection part. Accordingly, when this configuration is employed, it is possible to further reduce the fuel consumption at the internal combustion engine.

Each of the two temperature detection parts may be provided on each of two external air temperature sensors that are different from each other, and the two external air temperature sensors may be arranged such that the temperature detection parts are close to each other. It is possible to allow the two temperature detection parts to be close to each other, for example, by arranging the two external air temperature sensors to be tilted with respect to each other.

In this case, the temperature detection parts of the two external air temperature sensors are arranged at a substantially similar temperature detection environment, and therefore, it is possible to reduce the dispersion of the detection temperature of the temperature detection part caused by the temperature detection environment.

Sensor cables each of which is connected to each of the two external air temperature sensors may be mutually bundled to a portion close to a connection part with the corresponding external air temperature sensor.

In this case, it is possible to prevent water droplets from being moved only to one of the external air temperature sensors and generating freezing only at the temperature detection part of one of the external air temperature sensors at a chilly or cold time.

According to an aspect of the present invention, since the determination of the external air temperature is performed on the basis of the detection temperature of the temperature detection part of which the detection temperature is higher among the two temperature detection parts, even when the detection accuracy of any one of the temperature detection parts is degraded, it is possible to avoid an erroneous detection that the external air temperature is lower than an actual external air temperature and starting of the operation of the second drive source. Accordingly, it is possible for the second drive source not to be unnecessarily operated, and it is possible to reduce the consumption of the in-vehicle energy by the second drive source.

### BRIEF DESCRIPTION OF THE DRAWINGS

FIG. 1 is a configuration view focusing on an air conditioner of a multiple drive source-equipped vehicle according to an embodiment of the present invention.

FIG. 2 is an external view of the multiple drive source-equipped vehicle according to the embodiment of the present invention.

FIG. 3 is a cross-sectional view that corresponds to a cross-section of FIG. 2 of the multiple drive source-equipped vehicle according to the embodiment of the present invention.

FIG. 4 is a IV arrow view of FIG. 3 of the multiple drive source-equipped vehicle according to the embodiment of the present invention.

FIG. 5 is a front view of a bracket used for attaching an external air temperature sensor according to the embodiment of the present invention.

FIG. 6 is a side view of the bracket used for attaching the external air temperature sensor according to the embodiment of the present invention.

FIG. 7 is a flowchart showing a control of the air conditioner of the multiple drive source-equipped vehicle according to the embodiment of the present invention.

FIG. 8 is a flowchart showing a control of the air conditioner of the multiple drive source-equipped vehicle according to the embodiment of the present invention.

FIG. 9 is a flowchart showing a control of the air conditioner of the multiple drive source-equipped vehicle according to the embodiment of the present invention.

FIG. 10 is a timing chart showing a control of the air conditioner of the multiple drive source-equipped vehicle according to the embodiment of the present invention.

FIG. 11 is a partial cross-sectional front view of the external air temperature sensor according to another embodiment of the present invention.

### DESCRIPTION OF THE EMBODIMENTS

An embodiment of the present invention will be described with reference to the drawings.

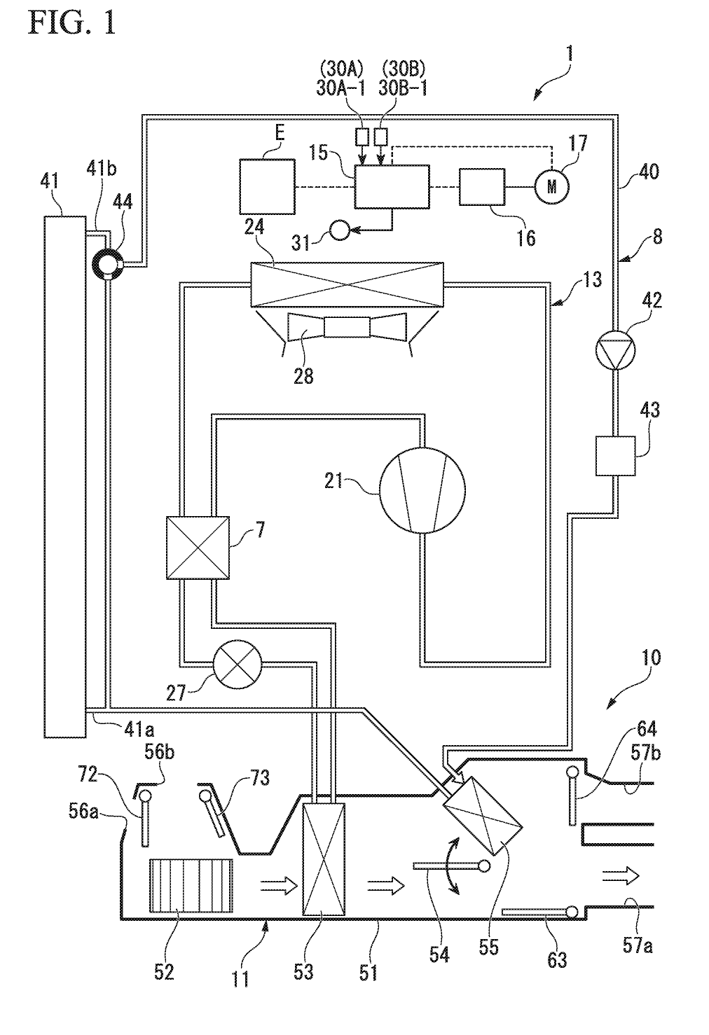

FIG. 1 is a view showing a configuration of a plug-in hybrid vehicle 1 as a form of a multiple drive source-equipped vehicle.

As shown in FIG. 1, the plug-in hybrid vehicle 1 includes: an electric motor 17 that performs driving of a vehicle and regeneration of electric power; a battery 16 that is capable of storing electric power; an internal combustion engine E that performs driving of the vehicle; an air conditioner 10 that performs air conditioning inside a vehicle room; and a controller 15 that controls the electric motor 17, the battery 16, the internal combustion engine E, and the air conditioner 10. The electric motor 17 is electrically connected to the battery 16 via an inverter (not shown).

The battery 16 is capable of being charged from an external electric source. In the present embodiment, the electric motor 17 constitutes a first drive source, and the internal combustion engine E constitutes a second drive source.

At the time of driving the electric motor 17, a DC current that is output from the battery 16 is converted into an AC current by the inverter and is supplied to the electric motor 17. The AC current is supplied to the electric motor 17, and thereby, the electric motor 17 generates a drive force. The drive force that is generated by the electric motor 17 is transmitted to a drive wheel of the vehicle. At the time of braking the vehicle, the electric motor 17 functions as an electric power generator. That is, the rotation of the drive wheel is transmitted to an output shaft of the electric motor 17, and by the rotation of the output shaft, electric power is regenerated at the electric motor 17. An AC current that is regenerated by the electric motor 17 is converted into a DC current by the inverter. The converted DC current is supplied to the battery 16 from the inverter and is stored in the battery 16.

The air conditioner 10 includes an air conditioning unit 11, a refrigerant circuit 13 for cooling, and a warm water circuit 8 for heating.

The air conditioning unit 11 includes an air conditioning duct 51 through which conditioning air flows, a blower 52, an evaporator 53, an air mix door 54, and a heater core 55. The blower 52, the evaporator 53, the air mix door 54, and the heater core 55 are accommodated inside the air conditioning duct 51.

The air conditioning duct 51 has air intake ports 56a, 56b and air-blowing ports 57a, 57b.

The blower 52, the evaporator 53, the air mix door 54, and the heater core 55 described above are arranged in this order toward a downstream side (air-blowing ports 57a, 57b side) from an upstream side (air intake ports 56a, 56b side) in a flow direction of the conditioning air in the air conditioning duct 51.

The air intake port 56a constitutes an internal air intake port that takes in internal air. The air intake port 56b constitutes an external air intake port that takes in external air. The air intake port 56a is opened and closed by an internal air door 72. The air intake port 56b is opened and closed by an external air door 73. For example, opening degrees of the internal air door 72 and the external air door 73 are adjusted by a control by the controller 15, and thereby, the ratio of flow volumes of the internal air and the external air that flow into the air conditioning duct 51 is adjusted.

The air-blowing port 57a constitutes a VENT blowing port. The air-blowing port 57b constitutes a DEF (DEFROST) blowing port. The air-blowing port 57a is capable of being opened and closed by a VENT door 63. The air-blowing port 57b is capable of being opened and closed by a DEF door 64. The air-blowing ports 57a, 57b are capable of changing a blowing position of the conditioning air with respect to the vehicle room inside, for example, by switching the VENT door 63 and the DEF door 64 between opening and closing by the control according to the controller 15.

In the blower 52, a voltage that is applied to a drive motor is controlled by the controller 15. The air volume of the blower 52 is adjusted by the control of the drive motor according to the controller 15. The blower 52 sends the conditioning air (at least one of internal air and external air) that is taken into the air conditioning duct 51 from the air intake ports 56a, 56b toward the downstream side, that is, the evaporator 53 and the heater core 55.

The evaporator 53 performs heat exchange between conditioning air inside the air conditioning duct 51 and a low-temperature and low-pressure refrigerant that flows into the inside of the evaporator 53 and cools the conditioning air that passes through the evaporator 53, for example, by heat absorption when the refrigerant evaporates.

The heater core 55 performs heat exchange between the conditioning air and high-temperature circulation liquid (heat conduction refrigerant liquid) that flows into the inside of the heater core 55. The heater core 55 releases heat of the circulation liquid that flows through the inside of the heater core 55 and thereby heats the conditioning air that passes through the heater core 55.

The air mix door 54 is operated to be rotated, for example, by a control by the controller 15.

The air mix door 54 is rotated between a heating position at which an air flow path toward the heater core 55 from the downstream of the evaporator 53 inside the air conditioning duct 51 is released and a cooling position at which an air flow path that bypasses the heater core 55 is opened. Thereby, the ratio of an air volume of conditioning air that passes through the heater core 55 and an air volume of conditioning air that bypasses the heater core 55 of the conditioning air that passes through the evaporator 55 is adjusted.

The refrigerant circuit 13 has an electrically operated compressor 21, an external heat exchanger 24 that performs heat exchange between the refrigerant that is compressed by the compressor 21 and external air, a cooling expansion valve 27 that reduces the pressure of the refrigerant after performing the heat exchange at the external heat exchanger 24, and the evaporator 53 described above that performs heat exchange between flowing air inside the air conditioning unit 11 and the refrigerant of which the pressure is reduced by the cooling expansion valve 27. A refrigerant for air conditioning is filled inside the refrigerant circuit 13.

The compressor 21 is driven by a drive motor (not shown). The drive voltage of the drive motor is controlled by the controller 15, and thereby, an output (for example, a rotation speed) of the compressor 21 is capable of being changed. The compressor 21 increases the pressure of the refrigerant that is suctioned from the upstream side and discharges the refrigerant to the downstream side.

The external heat exchanger 24 is connected to the downstream side of the compressor 21 of the refrigerant circuit 13. The external heat exchanger 24 is arranged outside the vehicle room and performs heat exchange between a vehicle room outside atmosphere and the high-temperature and high-pressure refrigerant that flows into the inside of the external heat exchanger 24. An electrically operated external fan 28 is provided on the external heat exchanger 24. The external fan 28 is appropriately driven by a control by the controller 15 and prompts heat release at the external heat exchanger 24.

The cooling expansion valve 27 is connected to the downstream side of the external heat exchanger 24 of the refrigerant circuit 13. The cooling expansion valve 27 reduces the pressure of the refrigerant and expands the refrigerant, for example, in accordance with the valve opening degree that is controlled by the controller 15 and then discharges the refrigerant as a low-temperature and low-pressure refrigerant in a gas-liquid two-phase (liquid phase rich) mist state to the evaporator 53.

The evaporator 53 is connected to the downstream side of the cooling expansion valve 27 and the suction side of the compressor 21 of the refrigerant circuit 13. The evaporator 53 is arranged inside the air conditioning duct 51 as described above and performs heat exchange between the low-temperature and low-pressure refrigerant that passes through the cooling expansion valve 27 and the conditioning air inside the air conditioning duct 51. The refrigerant that passes through the evaporator 53 is allowed to return to a suction part of the compressor 21.

A cooling supplementary heat exchanger 7 in FIG. 1 is arranged to straddle an upstream side part of the cooling expansion valve 27 and a downstream side part of the evaporator 53 of the refrigerant circuit 13. When the cooling operation is performed, the cooling supplementary heat exchanger 7 performs heat exchange between the upstream side part of the cooling expansion valve 27 and the downstream side part of the evaporator 53 and cools the refrigerant at the upstream side part before flowing into the evaporator 53.

A heating main circuit 40 and an engine-cooling circuit 41 (second heating apparatus) that cools the internal combustion engine E are connected to constitute the warm water circuit 8. Circulation liquid (cooling liquid or heat conduction refrigerant liquid) is filled in the heating main circuit 40 and the engine-cooling circuit 41.

The heating main circuit 40 has an electric pump 42 that sends circulation liquid, an electric heater 43 (first heating apparatus) such as a ceramic heater that heats the circulation liquid, and the heater core 55 described above that performs heat exchange between the conditioning air inside the air conditioning duct 51 and the circulation liquid that is heated by the electric heater 43.

The engine-cooling circuit 41 has an introduction part 41a and a delivery part 41b of the circulation liquid. The introduction part 41a of the engine-cooling circuit 41 is connected to a downstream side part of the heater core 55 of the heating main circuit 40. The delivery part 41b of the engine-cooling circuit 41 is connected to an upstream side part of the electric pump 42 of the heating main circuit 40.

The engine-cooling circuit 41 is capable of being connected to and disconnected from the heating main circuit 40 via a flow path-switching valve 44 such as a three-way valve. In a state where the engine-cooling circuit 41 is connected to the heating main circuit 40 by the flow path-switching valve 44, the circulation liquid which passes through the engine-cooling circuit 41 (internal combustion engine E) and of which the temperature is increased is allowed to return to the electric pump 42, and the circulation liquid is further heated by the electric heater 43 and is introduced to the heater core 55. Therefore, when the internal combustion engine E is operated, it is possible to increase the temperature of the heater core 55 by using the combustion heat. It is also possible to increase the temperature of the heater core 55 by only the heat of the circulation liquid of which the temperature is increased by the engine-cooling circuit 41 without operating the electric heater 43 depending on the drive situation of the air conditioner 10.

In the case of the present embodiment, the first heating apparatus is constituted of the electric heater 43 as a main part. The second heating apparatus is constituted of the engine-cooling circuit 41 that performs heat exchange with the internal combustion engine E as a main part.

The controller 15 controls the air conditioner 10 on the basis of a setting by a variety of air conditioning switches inside the vehicle room. Specifically, the controller 15 appropriately controls the rotation speeds of the compressor 21, the external fan 28, the blower 52, and the like in the refrigerant circuit 13, the opening degree of the air mix door 54, the opening and closing states of the internal air door 72 and the external air door 73, the electric pump 42 of the warm water circuit 8 being driven or not, the switching of the flow path-switching valve 44, and the like in accordance with a room inside temperature setting, a drive mode setting, and the like.

Further, the controller 15 controls the electric motor 17 and the battery 16 in accordance with the driving operation and the travel situation. Information of the residual amount (SOC: State of Charge) of electric power of the battery 16, information of regeneration of electric power by the electric motor 17, and the like are input to the controller 15.

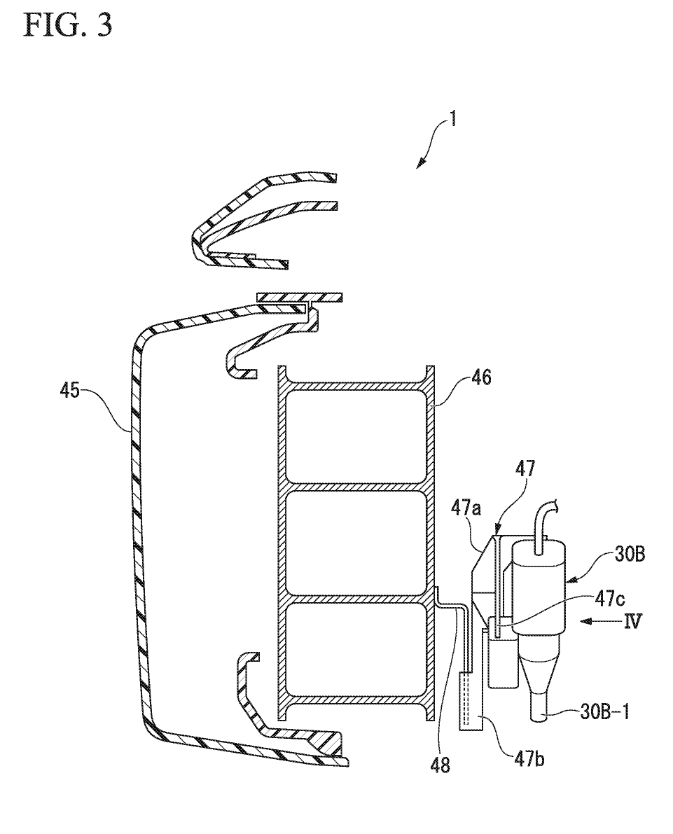

Two external air temperature sensors 30A, 30B for detecting the temperature of external air are connected to an input part of the controller 15. The external air temperature sensor 30A has a temperature detection part 30A-1 (refer to FIG. 3 to FIG. 6) that is formed of, for example, a thermistor and the like. The external air temperature sensor 30B has a temperature detection part 30B-1 (refer to FIG. 3 to FIG. 6) that is formed of, for example, a thermistor and the like. The controller 15 receives a detection signal that is detected by the temperature detection parts 30A-1, 30B-1 of the external air temperature sensors 30A, 30B and performs a control of each part of the air conditioner 10. Specifically, when the heating operation is performed in a situation in which the vehicle is driven by the electric motor 17, the controller 15 performs switching between a heating operation by only the first heating apparatus of which the main part is the electric heater 43 and a heating operation in which the second heating apparatus of which the main part is the engine-cooling circuit 41 is used by using the detection signal of the two temperature detection parts 30A-1, 30B-1 of the external air temperature sensors 30A, 30B. This control is described in detail later.

Further, the detection signal of the two temperature detection parts 30A-1, 30B-1 of the external air temperature sensors 30A, 30B is also used for determination of the degradation (also including a failure) of the detection accuracy of the temperature detection parts 30A-1, 30B-1. An alarm lamp 31 for notifying an occupant or an operator, when it is determined that the detection accuracy of any one of the external air temperature sensors 30A, 30B is degraded, of the degradation of the detection accuracy of any one of the external air temperature sensors 30A, 30B is connected to an output part of the controller 15. The alarm lamp 31 is a form of an alarm apparatus, and the alarm apparatus is not limited to the alarm lamp 31.

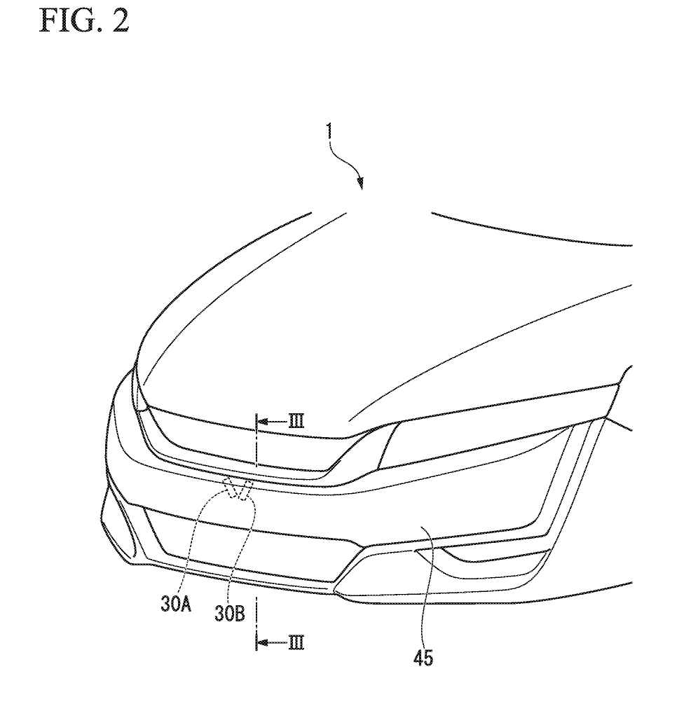

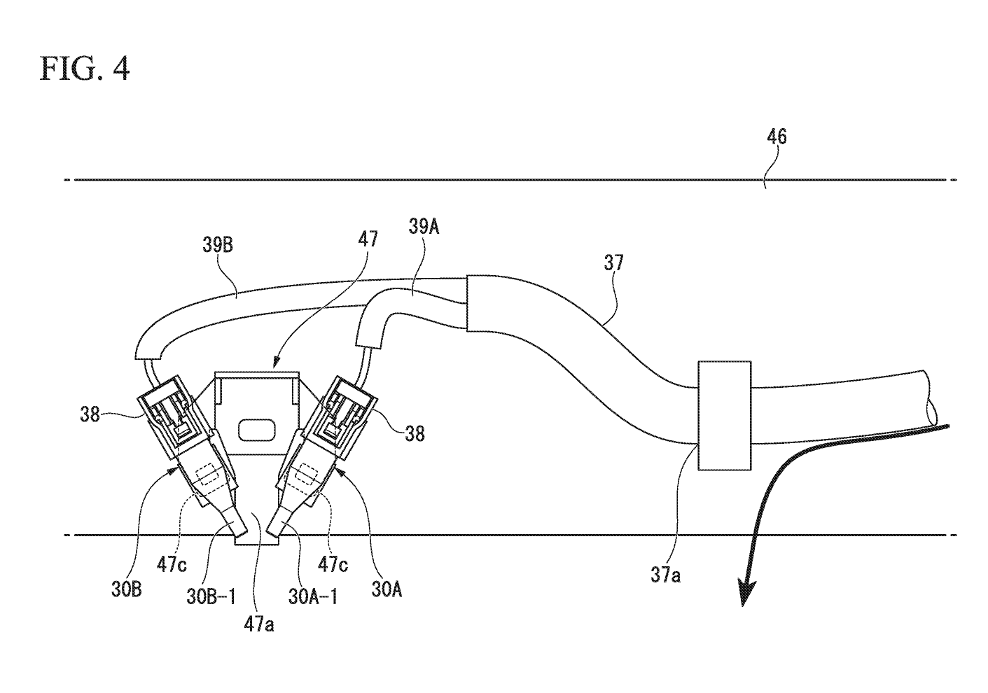

FIG. 2 is a view showing an external appearance of the plug-in hybrid vehicle 1 on which the two external air temperature sensors 30A, 30B are provided. FIG. 3 is a view showing a cross-section of the plug-in hybrid vehicle 1 that corresponds to a III-III cross-section of FIG. 2. FIG. 4 is a IV arrow view of FIG. 3.

In the case of the present embodiment, the external air temperature sensors 30A, 30B are attached via a bracket 47 to a back part (rear part) of a bumper beam 46 of a front bumper 45. The bracket 47 is fixed in a fit state to a stay 48 that has a plate shape and that is provided to protrude downward at a back surface (rear surface) of the bumper beam 46.

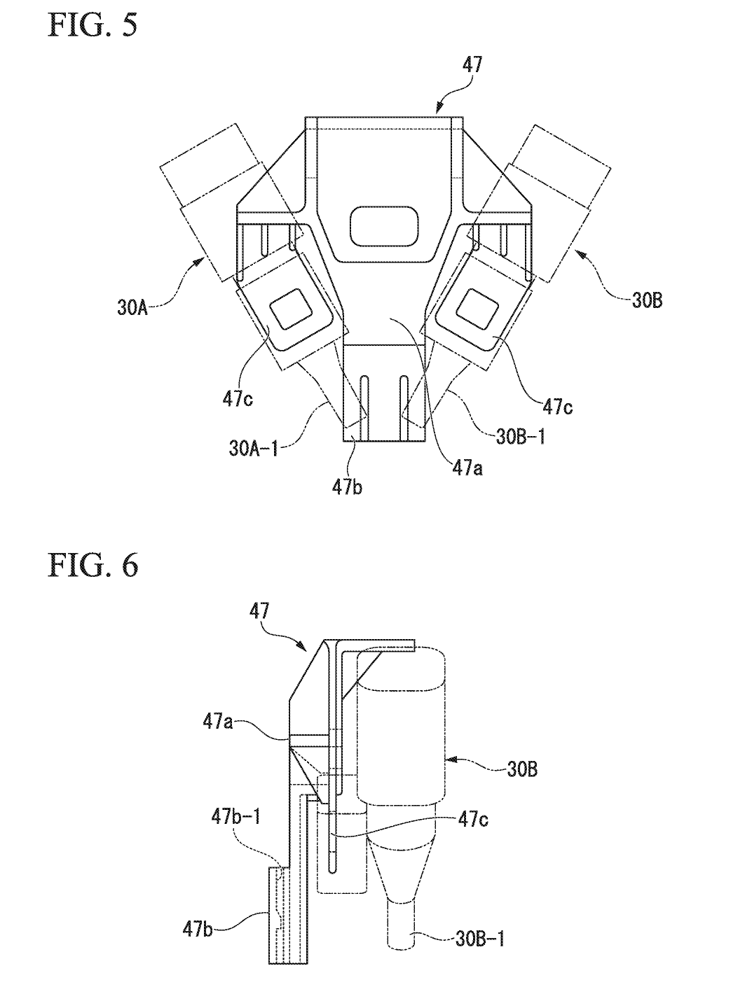

FIG. 5 is a front view of the bracket 47. FIG. 6 is a side view of the bracket 47.

As shown in FIG. 5 and FIG. 6, the bracket 47 has a bracket main body 47a having a substantially T shape in a front view, a latch block 47b that is integrally formed on a lower edge of the bracket main body 47a, and a pair of latch claws 47c that protrude diagonally downward inward from right and left side edges on an upper side of the bracket main body 47a. The latch block 47b has a latch groove 47b-1 (refer to FIG. 6) that opens to an upward side. The latch groove 47b-1 is fitted to a front end part of the stay 48 having a plate shape on the back part of the bumper beam 46. Latch grooves (not shown) of the external air temperature sensors 30A, 30B are fitted to the pair of latch claws 47c. The external air temperature sensors 30A, 30B that are fixed in a fit state to the pair of latch claws 47c are arranged as shown in FIG. 4 and FIG. 5 such that the temperature detection parts 30A-1, 30B-1 of the external air temperature sensors 30A, 30B are close to each other in the vicinity of a lower edge part of the bracket main body 47a.

The width of the latch claw 47c of the bracket 47 is set to the same as the width of the front end part of the stay 48. The thickness of the latch claw 47c of the bracket 47 is set to the same as the thickness of the front end part of the stay 48. Therefore, the latch grooves of the external air temperature sensors 30A, 30B are capable of being fitted and fixed also to the front end part of the stay 48. Accordingly, in a vehicle of a specification in which the two external air temperature sensors 30A, 30B are not used, it is also possible to fit and fix one external air temperature sensor to the stay 48 and to use the one external air temperature sensor.

As shown in FIG. 4, a sensor cable 39A is connected via a connector 38 to the external air temperature sensor 30A, and a sensor cable 39B is connected via a connector 38 to the external air temperature sensor 30B. The sensor cables 39A, 39B are arranged inside an engine room and are connected to the controller 15. The two sensor cables 39A, 39B are mutually bundled by a cable cover 37 and the like to the vicinity of a connection part with the corresponding external air temperature sensors 30A, 30B. A lower position part 37a that is lower than an immediately upper portion of the connection part with the external air temperature sensors 30A, 30B is provided at the bundled part by the cable cover 37 and the like of the two sensor cables 39A, 39B. Therefore, water droplets that move along the cable cover 37 fall in drops downward through the lower position part 37a as shown in an arrow in FIG. 4. Accordingly, the water droplets that move along the cable cover 37 do not easily flow into the external air temperature sensors 30A, 30B side.

When the heating operation is performed at the time of vehicle driving by the electric motor 17, the controller 15 determines whether or not an external air temperature is lower than a predetermined value on the basis of a detection signal of a temperature detection part of which a detection temperature is higher among the two temperature detection parts 30A-1, 30B-1 of the external air temperature sensors 30A, 30B. Then, when it is determined that the external air temperature is not lower than the predetermined value, the controller 15 continues the heating operation by the electric heater 43. When it is determined that the external air temperature is lower than the predetermined value, the controller 15 starts the internal combustion engine E, connects the engine-cooling circuit 41 to the heating main circuit 40, and performs the heating operation in which the heat (combustion heat of the internal combustion engine E) of the engine-cooling circuit 41 is used.

Further, the controller 15 compares detection temperatures of the two temperature detection parts 30A-1, 30B-1 of the external air temperature sensors 30A, 30B and determines that the detection accuracy of any one of the external air temperature sensors (any one of the temperature detection parts) is degraded (breaks down) when the temperature difference between detection temperatures by the two temperature detection parts 30A-1, 30B-1 is larger than a predetermined temperature difference. Then, when it is determined that the detection accuracy of any one of the external air temperature sensors 30A, 30B is degraded, the controller 15 stops performing the heating operation in which the heat (combustion heat of the internal combustion engine E) of the engine-cooling circuit 41 is used and lights the alarm lamp 31.

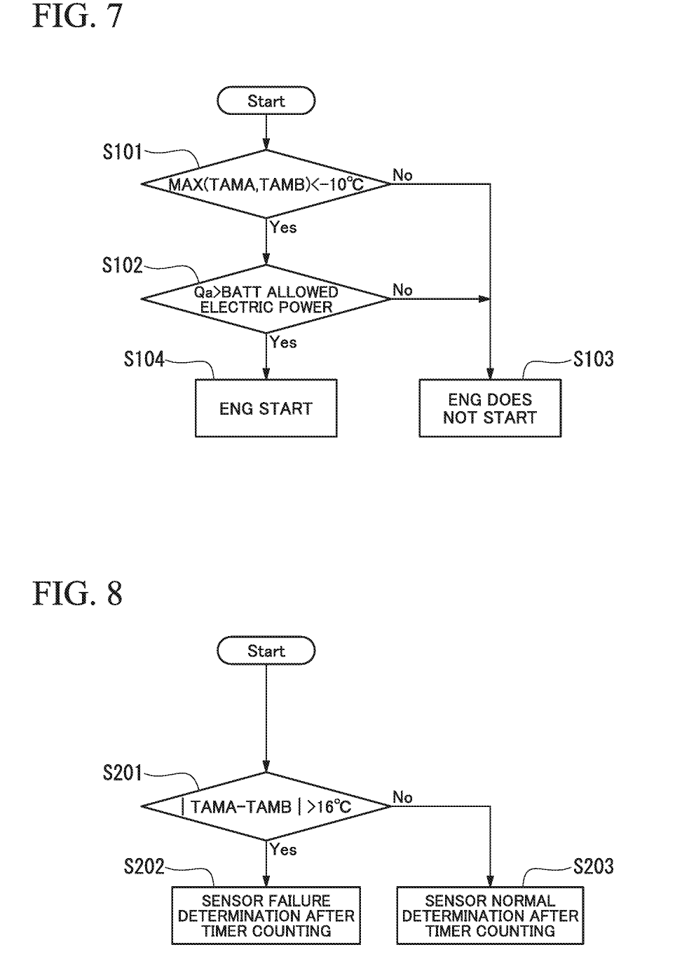

Hereinafter, a flow of a specific control when the heating operation is performed at the time of vehicle driving by the electric motor 17 is described with reference to FIG. 7 to FIG. 10.

When the heating operation is started at the time of vehicle driving by the electric motor 17, in the controller 15, as shown in Step S101 of FIG. 7, the detection temperatures of the two temperature detection parts 30A-1, 30B-1 of the external air temperature sensors 30A, 30B are compared, and it is determined whether or not a higher detection temperature among the detection temperatures TAMA, TAMB is lower than a predetermined value (for example, −10° C.). When the higher detection temperature among the detection temperatures TAMA, TAMB is lower than the predetermined value, the routine proceeds to Step S102. When the higher detection temperature among the detection temperatures TAMA, TAMB is not lower than the predetermined value, the routine proceeds to Step S103, and the heating operation by the electric heater 43 is continued without starting the internal combustion engine E.

When the routine proceeds from Step S101 to Step S102, it is determined whether or not a current heating load Qa (electric power conversion value) is larger than maximum electric power of the electric heater 43 that is determined by a voltage of the battery 16. When the current heating load Qa is not larger than the maximum electric power of the electric heater 43, the routine proceeds to Step S103, and the heating operation by the electric heater 43 is continued without starting the internal combustion engine E. On the other hand, when the current heating load Qa is larger than the maximum electric power of the electric heater 43, the routine proceeds to Step S104, the internal combustion engine E is started, and the heating operation in which the heat (combustion heat of the internal combustion engine E) of the engine-cooling circuit 41 is used is performed.

The heating load Qa means a heating load that is determined by a detection value such as an external air temperature sensor, an internal air temperature sensor, or an insolation sensor, an air conditioning setting by the occupant, and the like.

Further, when determining the degradation (also including a failure) of the detection accuracy of the temperature detection parts 30A-1, 30B-1 of the external air temperature sensors 30A, 30B, as shown in Step S201 of FIG. 8, the detection temperatures of the two temperature detection parts 30A-1, 30B-1 are compared, and it is determined whether or not the detection temperature difference of the two temperature detection parts 30A-1, 30B-1 is larger than a predetermined temperature difference (for example, 16° C.). When the detection temperature difference of the two temperature detection parts 30A-1, 30B-1 is larger than the predetermined temperature difference, the routine proceeds to Step S202. When the detection temperature difference of the two temperature detection parts 30A-1, 30B-1 is not larger than the predetermined temperature difference, the routine proceeds to Step S203.

In Step S202, it is determined by the counting using a timer (failure NG timer) whether or not a state in which the detection temperature difference is larger than the predetermined temperature difference continues for a predetermined period of time or more, and when the state in which the detection temperature difference is larger than the predetermined temperature difference continues for a predetermined period of time or more, it is determined that there is degradation (failure) of the detection accuracy at any of the external air temperature sensors (temperature detection parts). Then, the controller 15 stops performing the heating operation in which the heat (combustion heat of the internal combustion engine E) of the engine-cooling circuit 41 is used and lights the alarm lamp 31.

When the state in which the detection temperature difference is larger than the predetermined temperature difference continues for a predetermined period of time or more, the routine returns to Step S201, and the process is repeated.

In Step S203, it is determined by the counting using a timer (failure OK timer) whether or not the state in which the detection temperature difference is not larger than the predetermined temperature difference continues for the predetermined period of time or more, and when the state in which the detection temperature difference is not larger than the predetermined temperature difference continues for the predetermined period of time or more, it is determined that there is no degradation (failure) of the detection accuracy at both the external air temperature sensors 30A, 30B (temperature detection parts 30A-1, 30B-1). When the state in which the detection temperature difference is not larger than the predetermined temperature difference does not continue for the predetermined period of time or more, the routine returns to Step S201, and the process is repeated.

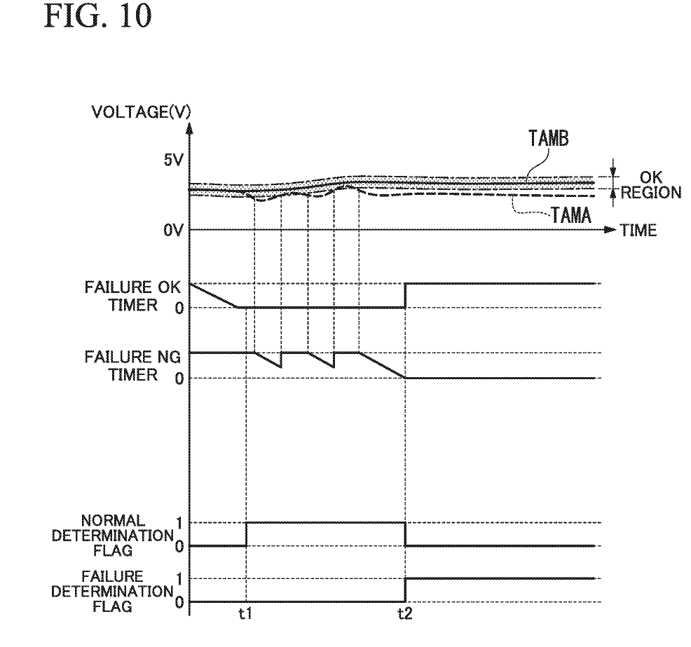

FIG. 10 is a timing chart showing an example of the detection values of the external air temperature sensors 30A, 30B, the states of a normal determination timer (failure OK timer) and a failure determination timer (failure NG timer), and the states of a normal determination flag and a failure determination flag when the degradation (failure) of the detection accuracy of the temperature detection parts 30A-1, 30B-1 is determined.

At a time t1 of FIG. 10, in Step S203 of FIG. 8, the state in which the detection temperature difference of the temperature detection parts 30A-1, 30B-1 is not larger than the predetermined temperature difference continues for a predetermined period of time or more. As a result, the normal determination flag becomes 1 at the time t1, and a normal determination in which there is no degradation (failure) of the detection accuracy at both temperature detection parts 30A-1, 30B-1 is determined.

At a time t2 of FIG. 10, in Step S202 of FIG. 8, the state in which the detection temperature difference of the temperature detection parts 30A-1, 30B-1 is larger than the predetermined temperature difference continues for a predetermined period of time or more. As a result, the failure determination flag becomes 1 at the time t2, and an abnormal determination in which there is degradation (failure) of the detection accuracy at any of the temperature detection parts 30A-1, 30B-1 is determined.

After it is determined that there is degradation (failure) of the detection accuracy at any of the temperature detection parts 30A-1, 30B-1 of the external air temperature sensors 30A, 30B in Step S202 of FIG. 8, it is possible to start the internal combustion engine E by a switch operation by the occupant or the like and perform the heating operation in which the heat (combustion heat of the internal combustion engine E) of the engine-cooling circuit 41 is used.

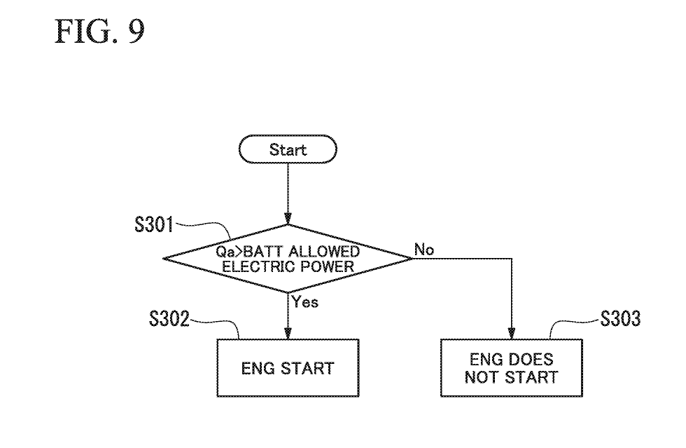

That is, when a switch operation by the occupant or the like is performed after it is determined that there is degradation (failure) of the detection accuracy at the temperature detection parts 30A-1, 30B-1 of the external air temperature sensors 30A, 30B, as shown in Step S301 of FIG. 9, it is determined whether or not the current heating load Qa (electric power conversion value) is larger than the maximum electric power of the electric heater 43. When the current heating load Qa is larger than the maximum electric power of the electric heater 43, the routine proceeds to Step S302. When the current heating load Qa is not larger than the maximum electric power of the electric heater 43, the routine proceeds to Step S303. When the routine proceeds to Step S302, the internal combustion engine E is started, and the heating operation in which the heat (combustion heat of the internal combustion engine E) of the engine-cooling circuit 41 is used is performed. For example, the detection temperature of the external air temperature sensors 30A, 30B (temperature detection parts 30A-1, 30B-1) immediately before the failure or the like can be used for the calculation of the heating load Qa.

When the routine proceeds to Step S303, the heating operation by the electric heater 43 is continued without starting the internal combustion engine E.

As described above, the plug-in hybrid vehicle 1 of the present embodiment includes two temperature detection parts 30A-1, 30B-1 of the external air temperature sensors 30A, 30B, and at the time of the heating operation, the controller 15 performs a determination of the external air temperature on the basis of the detection temperature of the temperature detection part of which the detection temperature is higher among the two temperature detection parts 30A-1, 30B-1. Therefore, even when the detection accuracy of any one of the temperature detection parts is degraded, it is possible to avoid a problem in which the internal combustion engine E is started on the basis of the detection result of the temperature detection part of which the detection accuracy is degraded. Accordingly, when the hybrid vehicle 1 of the present embodiment is employed, it is possible to avoid an unnecessary start of the internal combustion engine E at the time of vehicle driving by the electric motor 17, and it is possible to reduce the fuel consumption by the internal combustion engine E.

In the plug-in hybrid vehicle 1 of the present embodiment, when the difference between detection temperatures by the two temperature detection parts 30A-1, 30B-1 of the external air temperature sensors 30A, 30B is larger than the predetermined temperature difference, the controller 15 determines that the detection accuracy of any one of the temperature detection parts 30A-1, 30B-1 of the external air temperature sensors 30A, 30B is degraded and stops performing the heating operation by the engine-cooling circuit 41 in which the internal combustion engine E is started. Therefore, in a case where the configuration of the present embodiment is employed, if the detection accuracy of the remaining temperature detection part is degraded after the degradation of the detection accuracy of any of the temperature detection parts is found, it is possible to avoid the heating operation by the engine-cooling circuit 41 being performed while starting the internal combustion engine E on the basis of the erroneous detection temperature.

Further, in the plug-in hybrid vehicle 1 of the present embodiment, when the difference between detection temperatures by the two temperature detection parts 30A-1, 30B-1 is larger than the predetermined temperature difference, the controller 15 determines that the detection accuracy of any one of the temperature detection parts is degraded and lights the alarm lamp 31. Therefore, when the detection accuracy of one of the temperature detection parts is degraded, it is possible to promptly notify an occupant or an operator of the degradation of the detection accuracy of one of the temperature detection parts through the lighted alarm lamp 31. Further, when the detection accuracy of one of the temperature detection parts is degraded, and the controller 15 stops performing the heating operation by the engine-cooling circuit 41 in which the internal combustion engine E is started, it is possible to promptly notify the occupant of the stopping of the heating operation. Therefore, when the vehicle room inside is not sufficiently warmed and the like, it is possible for the occupant, through a manual operation, to perform the heating operation by the engine-cooling circuit 41 in which the internal combustion engine E is started.

Further, in the hybrid vehicle 1 of the present embodiment, the two external air temperature sensors 30A, 30B are arranged such that the temperature detection parts 30A-1, 30B-1 are close to each other. Therefore, the temperature detection parts 30A-1, 30B-1 of the two external air temperature sensors 30A, 30B are arranged at a substantially similar temperature detection environment, and it is possible to reduce the dispersion of the detection temperature at the temperature detection parts 30A-1, 30B-1 caused by the temperature detection environment. Further, the temperature detection parts 30A-1, 30B-1 of the two external air temperature sensors 30A, 30B are arranged at the substantially similar temperature detection environment, and therefore, it is possible to further accurately detect the degradation of the detection accuracy of one of the temperature detection parts.

Specifically, in the case of the present embodiment, the two external air temperature sensors 30A, 30B are attached to the back part of the bumper beam 46 of the front bumper 45, and therefore, rainwater, vehicle wash water, and the like are not easily attached to the external air temperature sensors 30A, 30B. Therefore, it is possible to prevent freezing and the like from being generated on the temperature detection parts 30A-1, 30B-1 of the external air temperature sensors 30A, 30B.

Further, in the hybrid vehicle 1 of the present embodiment, the sensor cables 39A, 39B that are connected to the two external air temperature sensors 30A, 30B, respectively, are mutually bundled to a portion close to the connection part with the corresponding external air temperature sensors 30A, 30B. Therefore, it is possible to prevent water droplets from being moved only to one of the external air temperature sensors through the sensor cables 39A, 39B and generating freezing only on the one of the external air temperature sensors at a chilly or cold time.

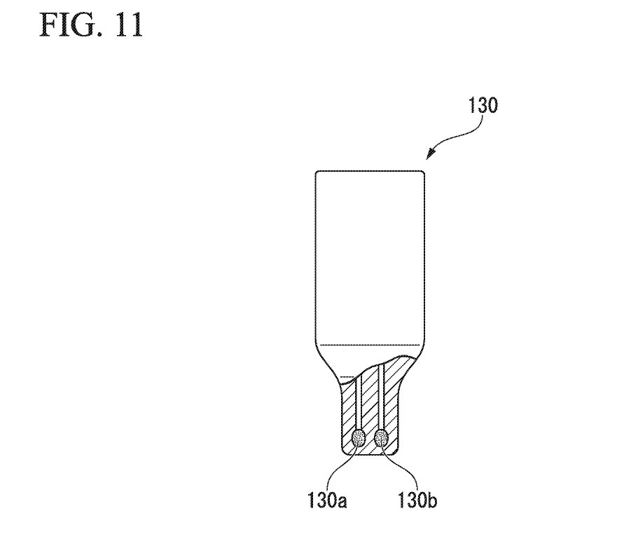

The present invention is not limited to the embodiment described above, and a variety of design changes can be made without departing from the scope of the invention. For example, in the embodiment described above, the two external air temperature sensors 30A, 30B each having one of the temperature detection parts 30A-1, 30B-1 are used; however, as shown in FIG. 11, it is also possible to use one external air temperature sensor 130 having two temperature detection parts 130a, 130b.

Further, in the hybrid vehicle 1 of the embodiment described above, the vehicle driving by the electric motor 17 and the vehicle driving by the internal combustion engine E are available; however, the internal combustion engine E may be one which is used only for power generation. In this case, the electric power that is generated by the internal combustion engine by consuming the fuel can be charged to the battery 16 and can be used for driving the electric motor 17.

Further, the above embodiment is described using an example of a hybrid vehicle that uses the electric motor 17 and the internal combustion engine E; however, the multiple drive source-equipped vehicle is not limited to the hybrid vehicle. For example, the second drive source that consumes in-vehicle energy other than the electric power that is stored in the battery may be a fuel cell, an external combustion engine such as a gas turbine engine and a Stirling engine, and the like.

Further, the first heating apparatus that uses the electric power of the battery is not limited to the electric heater 43. The first heating apparatus may be a heat pump system that uses an electrically operated compressor or another system that performs heating by electric power.

1. A multiple drive source-equipped vehicle that comprises:
a battery that is capable of storing electric power;
a first drive source that is capable of driving a vehicle by the electric power that is stored in the battery;
a second drive source that is capable of driving the vehicle by consuming in-vehicle energy other than the electric power that is stored in the battery;
a first heating apparatus that is capable of heating a vehicle room inside by using the electric power that is stored in the battery;
a second heating apparatus that is capable of heating the vehicle room inside by using heat that is generated by an operation of the second drive source; and
a controller that performs a drive control of the first drive source, a drive control of the second drive source, a control of a heating operation by the first heating apparatus, and a control of a heating operation by the second heating apparatus, the vehicle comprising
two temperature detection parts configured to detect a temperature of external air,
wherein, when a heating operation is performed at a time of vehicle driving by the first drive source, the controller: determines whether or not an external air temperature is lower than a predetermined value based on a detection temperature of a temperature detection part of which a detection temperature is higher among the two temperature detection parts; continues a heating operation by the first heating apparatus when it is determined that the external air temperature is not lower than the predetermined value; and operates the second drive source and performs a heating operation by the second heating apparatus when it is determined that the external air temperature is lower than the predetermined value.

2. The multiple drive source-equipped vehicle according to claim 1,
wherein when a temperature difference between detection temperatures by the two temperature detection parts is larger than a predetermined temperature difference, the controller determines that a detection accuracy of any one of the temperature detection parts is degraded and stops performing the heating operation by the second heating apparatus.

3. The multiple drive source-equipped vehicle according to claim 2, further comprising
an alarm apparatus configured to set off an alarm indicating a failure of the temperature detection part,
wherein when a temperature difference between detection temperatures by the two temperature detection parts is larger than a predetermined temperature difference, the controller determines that a detection accuracy of any one of the temperature detection parts is degraded and operates the alarm apparatus.

4. The multiple drive source-equipped vehicle according to claim 1,
wherein the first drive source is constituted of an electric motor, and the second drive source is constituted of an internal combustion engine.

5. The multiple drive source-equipped vehicle according to claim 1,
wherein each of the two temperature detection parts is provided on each of two external air temperature sensors that are different from each other, and the two external air temperature sensors are arranged such that the temperature detection parts are close to each other.

6. The multiple drive source-equipped vehicle according to claim 5,
wherein sensor cables each of which is connected to each of the two external air temperature sensors are mutually bundled to a portion close to a connection part with the corresponding external air temperature sensor.
